(19) United States
(12) Patent Application Publication
(10) Pub. No.: US 2014/0344305 A1
(43) Pub. Date: Nov. 20, 2014

(54) SYSTEM AND METHOD FOR MANAGING RELATED INFORMATION OF AUDIO CONTENT

(71) Applicant: HON HAI PRECISION INDUSTRY CO., LTD., New Taipei (TW)

(72) Inventors: YI-WEN CAI, New Taipei (TW); CHUN-MING CHEN, New Taipei (TW); CHUNG-I LEE, New Taipei (TW)

(73) Assignee: HON HAI PRECISION INDUSTRY CO., LTD., New Taipei (TW)

(21) Appl. No.: 13/972,955

(22) Filed: Aug. 22, 2013

(30) Foreign Application Priority Data
May 17, 2013 (TW) 102117479

(51) Int. Cl. G06F 17/30

(52) U.S. Cl. CPC G06F 17/30755
USPC 707/769

(57) ABSTRACT

A method for a first electronic device and a second electronic device to manage related information of audio content. The method obtains decoded data of ultrasound signals when receiving the ultrasound signals of the audio content. The method further receives a query keyword input from the first electronic device. When the received query keyword matches the decoded data, the related information of the audio content in the decoded data is output.

### BACKGROUND

1. Technical Field

Embodiments of the present disclosure relate to management technology, and particularly to a system and a method for managing related information of audio content.

2. Description of Related Art

A multimedia device, such as a television, a display screen of a computer device, may present image content. Therefore, image content of a multimedia program may be obtained and processed (e.g. being queried). However, it is not convenient or quick for users to query the audio content in the multimedia program.

### BRIEF DESCRIPTION OF THE DRAWINGS

FIG. 1 is a schematic diagram of one embodiment of a first electronic device and a second electronic device including a management system.

FIG. 2 is a block diagram of one embodiment of function modules of the management system in the first electronic device and the second electronic device in FIG. 1.

FIG. 3 is a flowchart illustrating one embodiment of a method of transmitting related information of audio content.

FIG. 4 is a flowchart illustrating one embodiment of a method of receiving the related information of the audio content.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

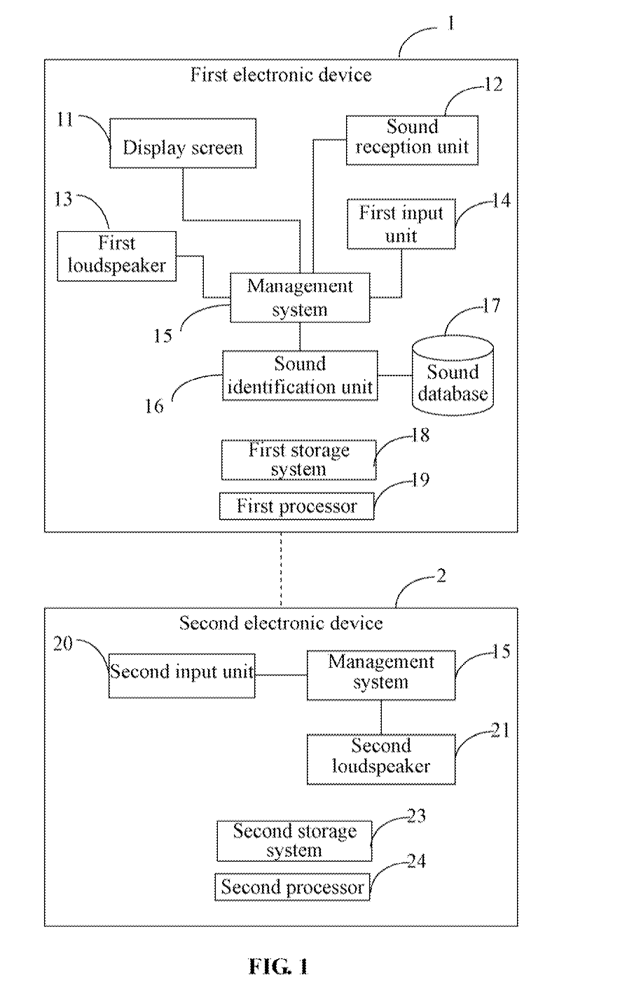

FIG. 1 is a schematic diagram of one embodiment of a first electronic device 1 and a second electronic device 2. The first electronic device 1 and the second electronic device 2 both include a management system 15. In one embodiment, the first electronic device 1 is a portable device, such as a tablet computer, a smart phone, or a notebook computer, for example. The second electronic device 2 is an electronic device including a loudspeaker to output sound data, such as a television or a radiogram. The second electronic device 2 communicates with a television (TV) station or a broadcasting station (not shown in FIG. 1) through a wireless connection using an antenna or a wired connection using cables, for example.

The second electronic device 2 receives a multimedia program (e.g. TV programs or television advertisings) which includes a audio content and receives related information of the audio content (e.g. sound signals) from the TV station or the broadcasting station. The related information may be keywords or specific nouns in the audio content in text form and/or in audio form.

The first electronic device 1 includes a display screen 11, a sound reception unit 12, a first loudspeaker 13, a first input unit 14, a sound identification unit 16, a sound database 17, a first storage system 18, and a first processor 19. The second electronic device 2 includes a second input unit 20 and a second loudspeaker 21, a second storage system 23, and a second processor 24.

The sound reception unit 12 may be a microphone for receiving ultrasound signals output by the second loudspeaker 24, and further receiving sound signals input to the first electronic device 1. The first loudspeaker 13 may output audible data. The first input unit 14 includes a virtual or physical keyboard, a touch panel, or a microphone that inputs audio signals or text signals in the first electronic device 1. The sound database 17 stores sound data corresponding to different texts, such as wave data of sounds, for example. The sound identification unit 16 analyzes audio signals input from the first input unit 14, and determines texts corresponding to the input audio signals according to wave data of the input audio signals. The sound identification unit 16 further converts the input audio signals to the determined texts.

The second input unit 20 uses an input interface for inputting signals of the multimedia program to the second loudspeaker 21, such as, an earphone interface or a High Definition Television (HDTV) interface, for example. The second input unit 20 may input audio or video. The second loudspeaker 21 may output audible data, and further output ultrasound signals that cannot be heard by human ears.

For simplification, depending on the embodiment, the second electronic device 2 is considered as a sender device for sending related information of audio content, and the first electronic device 1 is considered as a receiver device for receiving the related information of the audio content from the second electronic device 2. In another embodiment, the first electronic device 1 is the receiver device, and the second electronic device 2 is the sender device. The management system 15 may send and receive related information of the audio content between the first electronic device 1 and the second electronic device 2, and provide the related information in text form or in form of a sound according to a query request.

The first storage system 18 and the second storage system 23 store data for their respective electronic devices. The first storage system 18 or the second storage system 23 may be a memory, an external storage card, such as a smart media card, or a secure digital card. Both of the first processor 19 and the second processor 28 execute one or more computerized codes and other applications for their respective devices, to provide the functions of the management system 15.

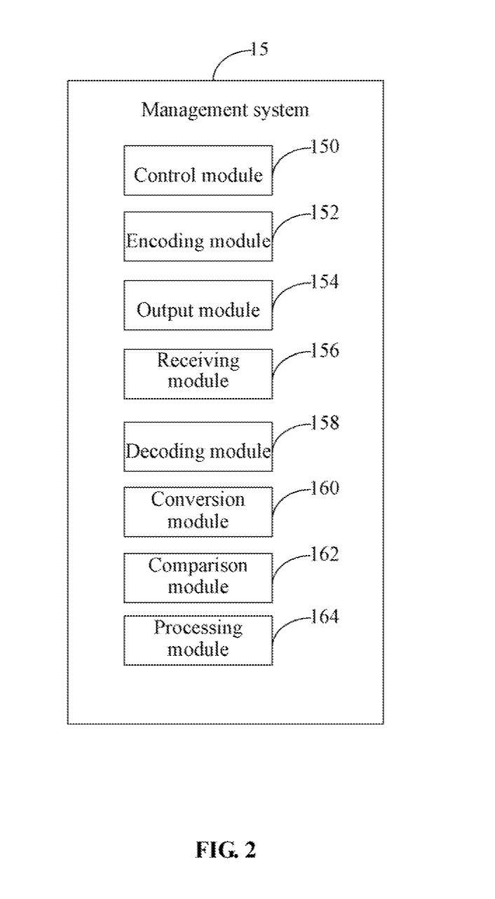

FIG. 2 is a block diagram of function modules of the management system 15 in the first electronic device 1 and in the second electronic device 2 of FIG. 1. In the embodiment, the management system 15 may include a control module 150, an encoding module 152, an output module 154, a receiving module 156, a decoding module 158, a conversion module 160, a comparison module 162, and a processing module 164. The modules 150, 152, 154, 156, 158, 160, 162, and 164 comprise computerized codes in the form of one or more programs that may be stored in each of the first storage system 18 and the second storage system 23. The computerized code includes instructions that are executed by the first processor 19 or by the second processor 24 to provide functions for the modules.

In one embodiment, if the second electronic device 2 is the sender device, the second electronic device 2 runs the modules 150, 152 and 154 to send the related information. If the first electronic device 1 is the receiver device, the first electronic device 1 executes the modules 156, 158, 160, 162 and 164 to receive the related information. Details of these operations follow.

When the second electronic device 2 receives audio content of a multimedia program from the TV station or a broadcasting station using the second input unit 20, the control module 150 controls the second loudspeaker 21 to output sounds of the audio content.

The encoding module 152 obtains related information of the received audio content, and encodes the related information. The encoding module 152 further converts the encoded related information into ultrasound signals. In one embodiment, the related information of the audio content includes, but is not limited to, specific nouns of the audio content (e.g. a program name, persons' name, place names, names of scenic spots about the audio content), and content descriptions of the specific nouns (e.g. brief introductions, extension information, or network links of the specific nouns).

In one embodiment, the encoding module 152 encodes the obtained related information into a packet, and converts the packet of the related information to the ultrasound signals using a preset modulation method, such as an orthogonal frequency-division multiplexing (OFDM) method. The packet includes, but is not limited to, an identification (ID) field, a type field, a length field, and a data field. The ID field stores an identifier of the packet to represent the related information. The type field stores the specific nouns in the audio content. The data field stores the content description of the specific nouns. The length field stores the length of the data field.

The output module 154 outputs the ultrasound signals to the first electronic device 1 using the second loudspeaker 21.

The receiving module 156 receives ultrasound signals using the sound reception unit 12 from the second electronic device 2, for example, receiving the converted ultrasound signals.

The decoding module 158 obtains decoded data (e.g. the packet of the related information) of the received ultrasound signals by decoding the received ultrasound signals according to the preset modulation method. The decoded data includes the related information of the audio content in the text form or in the audio form.

When a query keyword is input using the first input unit 14, the comparison module 162 determines whether the query keyword matches the decoded data by comparing the query keyword with specific nouns in the type field of the decode data. In one embodiment, the query keyword may be in the audio form, such as audio signals input from a microphone, or may be in the text form, such as characters input from a keyboard. When the query keyword and the related information in the decoded data are both in the audio form or in the text form, the comparison module 162 determines whether the query keyword matches the related information directly.

When the query keyword is in the audio form and the related information is in the text form, the conversion module 160 converts the query keyword from the audio form in the text form using the sound identification unit 16 and the sound database 17, and then the comparison module 162 compares the query keyword and the related information. When the related information is in the audio form and the query keyword is in the text form, the conversion module 160 converts the related information from the audio form to the text form, and then the comparison module 162 compares the query keyword and the related information.

In one embodiment, if the query keyword is the same as one of the specific nouns, the comparison module 230 determines that the decoded data matches the query keyword. If the query keyword is different from each of the specific nouns, the comparison module 230 determines that the decoded data does not match the query keyword.

When the query keyword matches the decoded data, the processing module 164 outputs the related information of the decoded data. In one embodiment, the processing module 164 outputs content descriptions in the data field of the decoded data. If the related information is in the audio form, the processing module 164 outputs the related information through the first loudspeaker 13. If the related information is in the text form, the processing module 164 outputs the related information through the display screen 11.

When the query keyword does not match the decoded data, the processing module 164 outputs a failure message of the query keyword. For example, the failure message is represented as “no matched related information, please reenter another query keyword”. When the query keyword is in the audio form, the processing module 164 outputs an audio file including the failure message through the first loudspeaker 13. When the query keyword is in the text form, the processing module 164 outputs texts including the failure message through the first display screen 30.

In other embodiments, when the first electronic device 1 receives audio content of a multimedia program, the comparison module 162 searches reference keywords which are the same as or similar to the query keyword in the audio content. The comparison module 162 outputs the searched reference keywords for a user to select, and confirms the selected reference keyword as a new query keyword to be compared with the decoded data. If the query keyword is in the audio form, the comparison module 162 searches the keywords that have same wave data of the query keyword. If the query keyword is in the text form, the conversion module 160 converts the audio content from the audio form to the text form, and the comparison muddle 162 searches the keywords that have same pronunciation (e.g. Chinese Pinyin pronunciation or English pronunciation) of the query keyword. When no reference keyword same as or similar to the query keyword in the audio content has been found, the comparison module 162 compares the query keyword with the decoded data directly.

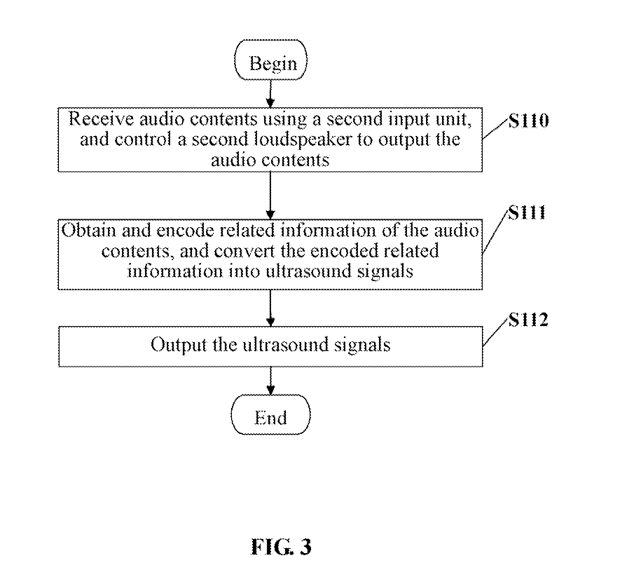

FIG. 3 is a flowchart illustrating one embodiment of a method of transmitting related information of audio content. Depending on the embodiment, additional steps may be added, others deleted, and the ordering of the steps may be changed.

In step S110, when the second electronic device 2 receives audio content of a multimedia program from the TV station or a broadcasting station using the second input unit 20, the control module 150 controls the second loudspeaker 21 to output sounds of the audio content.

In step S111, The encoding module 152 obtains and encodes related information of the received audio content, and converts the encoded related information into ultrasound signals. In one embodiment, the related information of the audio content may include, but is not limited to, specific nouns of the audio content, and content descriptions of the specific nouns.

In step S112, the output module 154 outputs the ultrasound signals to the first electronic device 1 using the second loudspeaker 21.

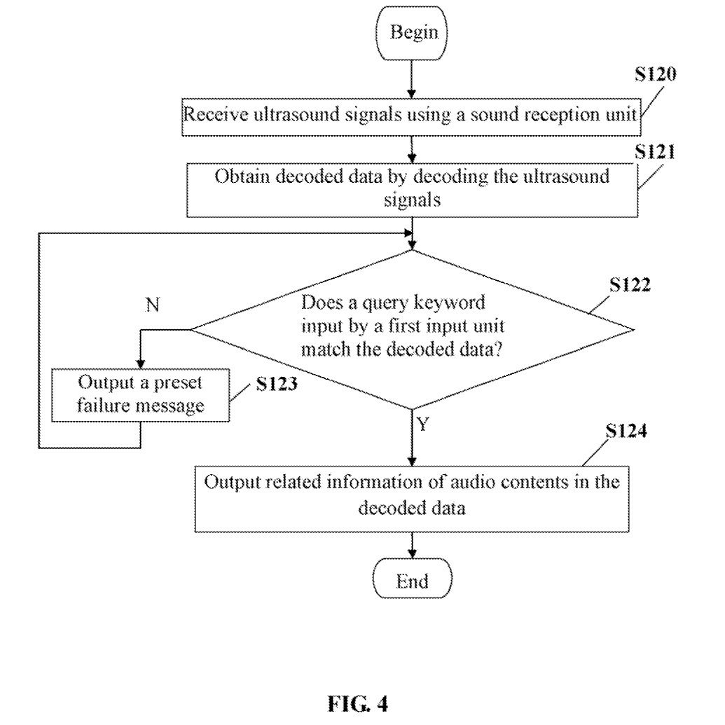

FIG. 4 is a flowchart illustrating one embodiment of a method of receiving the related information of the audio content. Depending on the embodiment, additional steps may be added, others deleted, and the ordering of the steps may be changed.

In step S120, The receiving module 156 receives ultrasound signals using the sound reception unit 12 from the second electronic device 2.

In step S121, the decoding module 158 obtains decoded data (e.g. the packet of the related information) of the received ultrasound signals by decoding the received ultrasound signals according to the preset modulation method. The decoded data includes the related information of the audio content in the text form or in the audio form.

In step S122, when a query keyword is input using the first input unit 14, the comparison module 162 determines whether the query keyword matches the decoded data by comparing the query keyword with specific nouns in the type field of the decode data. If the query keyword is the same as one of the specific nouns, the comparison module 230 determines that the decoded data matches the query keyword, and step S124 is implemented. If the query keyword is different from each of the specific nouns in the decoded data, the comparison module 230 determines that the query keyword does not match the decoded data, and step S123 is implemented.

In one embodiment, when the query keyword and the related information in the decoded data are both in the audio form or are both in the text form, the comparison module 162 determines whether the query keyword with the related information are same directly. When the query keyword is in the audio form and the related information is in the text form, the conversion module 160 converts the query keyword from the audio form to the text form, and then the comparison module 162 compares the query keyword and the related information. When the related information is in the audio form and the query keyword is in the text form, the conversion module 160 converts the related information from the audio form to the text form, and then the comparison module 162 compares the query keyword and the related information.

In step S123, the processing module 164 outputs a failure message of the query keyword, and step S122 is repeated for receiving a next query keyword to be compared. When the query keyword is in the audio form, the processing module 164 outputs an audio file including the failure message through the first loudspeaker 13. When the query keyword is in the text form, the processing module 164 outputs a texts including the failure message through the first display screen 30.

In step S124, the processing module 164 outputs related information of the decoded data. In one embodiment, the processing module 164 displays content description in the data field of the decoded data. If the related information is in the audio form, the processing module 164 outputs the related information through the first loudspeaker 13. If the related information is in the text form, the processing module 164 outputs the related information through the display screen 11.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for managing related information of audio content using a first electronic device and a second electronic device, the method comprising:
receiving ultrasound signals corresponding to the related information of the audio content from the second electronic device using a sound reception unit of the first electronic device;
obtaining decoded data of ultrasound signals by decoding the ultrasound signals according to a preset modulation method;
receiving a query keyword input from the first electronic device;
determining whether the received query keyword matches the decoded data; and
outputting the related information in the decoded data when the received query keyword matches the decoded data.

2. The method as described in claim 1, further comprising:
encoding the related information of the audio content by the second electronic device, when the second electronic device receives the audio content from a source device in communication with the second electronic device;
converting the encoded related information into the ultrasound signals by the second electronic device according to the preset modulation method; and
outputting the ultrasound signals to the first electronic device by the second electronic device.

3. The method as described in claim 1, further comprising:
converting the query keyword from an audio form to text form using a sound identification unit and a sound database in the first electronic device and comparing the query keyword and the related information, when the query keyword is in the audio form and the related information is in the text form;
converting the related information from the audio form into the text form, and comparing the query keyword and the related information, when the related information is in the audio form and the query keyword is in the text form.

4. The method as described in claim 1, further comprising:
searching reference keywords which are the same as or similar to the query keyword in the audio content, when the first electronic device receives the audio content; and
outputting the searched reference keywords, and selecting one of the searched reference keywords as a new query keyword to be compared with the decoded data.

5. The method as described in claim 1, wherein the related information is encoded into a packet which stores an identifier of the packet to represent the related information, specific nouns in the audio content, content descriptions of the specific nouns, and a length of the content descriptions.

6. The method as described in claim 5, wherein the related information in the decoded data is outputted by outputting the content descriptions of the specific nouns, and the related information is outputted through a loudspeaker of the first electronic device when the related information is in the audio form, or the related information is outputted through a display screen in the first electronic device when the related information is in the text form.

7. An electronic device for managing related information of audio content, the electronic device comprising:
at least one processor; and
a computer-readable storage medium storing one or more programs, which when executed by the at least one processor, the one or more programs comprising causes the at least one processor to:
receive ultrasound signals corresponding to the related information of the audio content from a sender device using a sound reception unit of the electronic device;
obtain decoded data of ultrasound signals by decoding the ultrasound signals according to a preset modulation method;
receive a query keyword input from the first electronic device;
determine whether the received query keyword matches the decoded data; and
output the related information in the decoded data when the received query keyword matches the decoded data.

8. The electronic device as described in claim 7, wherein the one or more programs further comprising causes the at least one processor to:
encoding the related information of the audio content, when the electronic device receives the audio content from a source device in communication with the electronic device;
converting the encoded related information into the ultrasound signals according to the preset modulation method; and
outputting the ultrasound signals.

9. The electronic device as described in claim 7, wherein the one or more programs further comprising causes the at least one processor to:
converting the query keyword from an audio form to a text form using a sound identification unit and a sound database in the first electronic device and comparing the query keyword and the related information, when the query keyword is in the audio form and the related information is in the text form;
converting the related information from the audio form to the text form, and comparing the query keyword and the related information, when the related information is in the audio form and the query keyword is in the text form.

10. The electronic device as described in claim 7, wherein the one or more programs further comprising causes the at least one processor to:
searching reference keywords which are the same as or similar to the query keyword in the audio content, when the first electronic device receives the audio content;
outputting the searched reference keywords, and selecting one of the searched reference keywords as a new query keyword to be compared with the decoded data.

11. The electronic device as described in claim 7, wherein the related information is encoded into a packet which stores an identifier of the packet to represent the related information, specific nouns in the audio content, content descriptions of the specific nouns, and a length of the content descriptions.

12. The electronic device as described in claim 11, wherein the related information in the decoded data is outputted by outputting the content descriptions of the specific nouns, and the related information is outputted through a loudspeaker in the first electronic device when the related information is in the audio form, or the related information is outputted through a display screen in the first electronic device when the related information is in the text form.

13. A non-transitory computer readable storage medium having stored thereon instructions that, when executed by a first electronic device and a second electronic device, causes the first and the second electronic device to perform a method for managing related information of audio content, the method comprising:
receiving ultrasound signals corresponding to the related information of the audio content from the second electronic device using a sound reception unit of the first electronic device;
obtaining decoded data of ultrasound signals by decoding the ultrasound signals according to a preset modulation method;
receiving a query keyword input from the first electronic device;
determining whether the received query keyword matches the decoded data; and
outputting the related information in the decoded data when the received query keyword matches the decoded data.

14. The non-transitory computer readable storage medium as described in claim 13, further comprising:
encoding the related information of the audio content by the second electronic device, when the second electronic device receives the audio content from a source device in communication with the second electronic device;
converting the encoded related information into the ultrasound signals by the second electronic device according to the preset modulation method; and
outputting the ultrasound signals to the first electronic device by the second electronic device.

15. The non-transitory computer readable storage medium as described in claim 11, further comprising:
converting the query keyword from an audio form into a text form using a sound identification unit and a sound database in the first electronic device and comparing the query keyword and the related information, when the query keyword is in the audio form and the related information is in the text form;
converting the related information from the audio form into the text form, and comparing the query keyword and the related information, when the related information is in the audio form and the query keyword is in the text form.

16. The non-transitory computer readable storage medium as described in claim 13, further comprising:
searching reference keywords which are the same as or similar to the query keyword in the audio content, when the first electronic device receives the audio content;
outputting the searched reference keywords, and selecting one of the searched reference keywords as a new query keyword to be compared with the decoded data.

17. The non-transitory computer readable storage medium as described in claim 16, wherein the related information is encoded into a packet which stores an identifier of the packet to represent the related information, specific nouns in the audio content, content descriptions of the specific nouns, and a length of the content descriptions.

18. The non-transitory computer readable storage medium as described in claim 17, wherein the related information in the decoded data is outputted by outputting the content descriptions of the specific nouns, and the related information is outputted through a loudspeaker in the first electronic device when the related information is in the audio form, or the related information is outputted through a display screen in the first electronic device when the related information is in the text form.
